(19) United States
(12) Patent Application Publication
(10) Pub. No.: US 2026/0173236 A1
(43) Pub. Date: Jun. 18, 2026

(54) AUTOMATED LIGHTING SYSTEM

(71) Applicant: SIGNIFY HOLDING B.V., EINDHOVEN (NL)

(72) Inventors: GERARDUS WILHELMUS THEODORUS VAN DER HEIJDEN, HAAREN (NL); KARIN WOUTERINA TESSA PULLEN, SPRANG-CAPELLE (NL)

(21) Appl. No.: 19/119,805

(22) PCT Filed: Oct. 10, 2023
(86) PCT No.: PCT/EP2023/077985

§ 371 Date: Apr. 10, 2025

(30) Foreign Application Priority Data
Oct. 17, 2022 (EP) 22201817.8

(51) Int. Cl. H05B 47/115; G01J 5/00; G01S 13/76

(52) U.S. Cl. CPC H05B 47/115; G01J 5/0025; G01S 13/765

(57) ABSTRACT

An automated lighting system (100) comprises at least one light (110) illuminating a lighting area (20), a motion detector (130) detecting a motion, and a controller (113, 120) controlling the light (110) in a normal operating mode based on the motion detection signal and in a presence scan mode. The presence scan mode is activated by the controller (120) after activation of the at least one light (110). The controller (113, 120) is configured to activate the light (110) dependent on a motion detection in a normal operating mode, and to deactivate the light after a holdtime. In the presence scan mode a presence of a mobile electronic device (300) associated to at least one person (200) is detected and a presence detection signal is outputted. The controller (113, 120) interrupts the deactivation of the light (110) before the hold time expires based on the presence detection signal.

### FIELD OF THE INVENTION

The present invention relates to an automated lighting system and a method for controlling an automated lighting system.

### BACKGROUND OF THE INVENTION

Automated lighting systems are well-known, where a motion detector is used to detect a motion in a lighting area and to activate the lights in the lighting system. Typically, after a holdtime, the lights will be switched off automatically. Alternatively, the lights can be switched off when a motion is detected which is indicative of a person leaving the lighting area.

US 2010/0171430 A1 discloses an automated lighting system, where a lighting device can detect and identify neighboring objects in the proximity of the device. The lights are switched on or off depending on the appearance or disappearance of neighboring objects in the area of the lighting device. Hence, the lights are switched on or off depending on the presence of an object or a person. Advantage of such a system is that the energy consumption can be reduced as failure to switch off the lights can be avoided.

US 2015/160673A1 discloses an occupancy sensing load control system including a detector unit, an occupancy/vacancy signal generator and a load control circuit. The detector unit detects RF signals emitted by cell phones or similar mobile communication devices within an area being monitored. The occupancy/vacancy signal generator generates a control signal for the load control circuit based on the detection of a qualified RF signal or the absence of such signal within a predetermined time interval. The occupancy sensing load control system may also include a signal-generating unit for generating a pseudo base station signal based on zone information of neighboring base stations for transmission to a mobile phone in the detection area.

### SUMMARY OF THE INVENTION

It is an object of the invention to provide an automated lighting system and a method for controlling an automated lighting system which allows intelligent energy savings without compromising the comfort of such a lighting system.

An automated lighting system is provided which comprises at least one light for illuminating at least part of a lighting area, at least one motion detector for detecting a motion of a person in the lighting area and to output a motion detection signal. The automated lighting system furthermore comprises a controller which is able to control an operation of the at least one light in a normal operation mode based on the motion detection signal from the motion detector and in a presence scan mode. The presence scan mode is activated after the activation of the at least one light. The controller can activate the at least one light dependent on the motion detection signal in a normal operating mode. The controller can deactivate the light after a holdtime. Furthermore, the controller can interrupt the deactivation of the light according to an interrupt signal based on a presence signal. The presence signal can be independent from the motion detection. In the presence scan mode a presence of a mobile electronic device associated to the person in the lighting area is detected and a presence detection signal is outputted. The controller is configured to interrupt the deactivation of the light before the hold time expires or extends the holdtime based on the presence detection signal.

Accordingly, the lights can be switched on when the motion detector has detected a motion in the lighting area. In the presence scan mode, the presence of the user in the lighting area is detected based on information of a presence of a mobile electronic device associated to a person in the lighting area. Once the presence of the electronic device is detected, the controller can deactivate the switching off of the lights. In other words, the controller is able to prolong the holdtime, namely the time during which the light is switched on. This is advantageous as any unwanted switching off of the lights can be avoided. This can also improve the comfort of a user as without the interruption of the deactivation the user has to perform a movement operation in order for the motion detector to again detect a motion in the lighting area and to activate the switches again. As this can be annoying, with the above-mentioned features it is possible to avoid any unwanted switching off of the lights.

The controller can be embodied as a main controller in form of a central controller. Alternatively, the controller can be embodied as a distributed controller, e.g. a controller in the lights. Hence, the prolonging of the hold time or the activation of the lights can be performed by a central controller or by a distributed controller depending on the set up of the lighting system.

In the presence scan mode, a scanning of a presence for a mobile electronic device is performed instead of a presence detection of the user. Thus, in the presence scanning mode, the presence of an electronic device associated to the user is determined. The presence of an electronic device in the lighting area can be detected by scanning RF signals. The scanning can be performed by the mobile electronic device, by one of the lights or by the controller. Once the presence of the electronic device is detected, then the controller can interrupt the deactivation or switching off of the lights and increase the holdtime or reset the holdtime. Thus, the energy consumption can be reduced without reducing the comfort of the user. The presence scanning can be performed continuously, in time intervals or at the end of the holdtime.

A presence detector can be part of the lighting system or can be independent from the lighting system. The presence detector can detect a presence of a mobile electronic device associated to a person using the lighting system in a lighting area and output a presence detection signal. The presence detection can be performed by the light, the motion detector and/or the controller. To do that, the light, the motion detector or the controller must be able to interact with the electronic device based on wireless RF signals. To start the interaction, the controller can activate a presence scan mode. In the presence scan mode, the light, the motion detector and/or the controller can initiate an RF signal scanning. If the RF signal scanning detects the mobile electronic device, then this is an indication that the mobile electronic device is within the coverage of the RF detection and thus the mobile electronic device is in the lighting area. This in turn gives an indication that the person to which the mobile device is associated is also in the lighting range. Thus, a presence of the person can be detected indirectly via the mobile electronic device and the switching off or deactivation of the lights can be interrupted.

Alternatively, the mobile device can initiate the start of the presence scanning (e.g. by searching for RF transmitters like lights of Bluetooth Low Energy BLE beacons etc.). For example, the mobile device can receive a notification or trigger from a controller in the system that a motion was detected by a motion detector. The processing of a notification or trigger and the subsequent initiation of the presence scanning can be performed by an application running of the mobile device. If the mobile device is wirelessly coupled to a smart wearing device (like a smart watch), the mobile device (like a smart phone) can then send an event to the smart wearing device. The mobile device can then also notify the controller that the person is still in the room and the holdtime can be prolonged. Optionally, if the mobile device detects that is no longer in reach of the RF transmitters (like the lights), it can turn off the lights and/or cancel the holdtime. This can for example be done by notifying the controller, which in turn can turn off the lights and/or cancel or reduce the holdtime.

The presence scan mode can be deactivated by the user of the lighting system based on user inputs to the mobile electronic device. This information can be forwarded from the mobile electronic device to the controller, where the presence scan mode is deactivated. Accordingly, the user can decide whether or not the presence scan mode can be activated and thus the holdtime can be interrupted based on an indirect presence detection of the user.

The light can comprise a light or luminaire, a wireless transceiver and a light controller. The wireless transceiver can allow an RF signal transmission and an RF signal reception. The light can thus communicate with the controller based on the RF signals. The RF signals can also be used to detect a motion in the lighting area. Here, the wireless receiver is used to receive RF signals from various lights in the lighting area. The light controller or the main controller can be used to determine motion signals based on received RF signals.

The lighting system can comprise a plurality of lights which each can act as network device. Thus, a network of network devices can be present. The network devices can be distributed in the lighting area and are configured to communicate with each other based on RF signals. At least one network device is configured to receive RF signals which have been transmitted by one other network device and have travelled through the sensing area. The receiving network device can output a sensing signal based on the received RF signal.

The network of network devices can also be understood as a sensing network comprising at least the network devices. Preferably, the network comprises more than three network devices, wherein the number of network devices in the network can be adapted based on the sensing area (lighting area). For example, a larger space may require more network devices.

The network of network devices can detect a status, a position and/or a posture of a person in the lighting area based on the signal strength of the plurality of detected sensing signals and/or based on channel state information derived from the plurality of detected sensing signals and the predetermined generated wireless sensing signal transmitted by a wireless transmitter in the network device. A status, position or posture of a person in the lighting area can be based on the signal strength of the plurality of detected sensing signals. Since a signal strength of the sensing signal depends on the amplitude of the wireless signal that directly or indirectly (via reflections/diffraction) reach the wireless receiver, the signal strength is indicative of the different paths the wireless signal can travel from the wireless transmitter to the wireless receiver. Since these paths are highly dependent on the environment between the transmitter and the receiver, they are thus also dependent on the position of a person in the environment. The signal strength can be indicative of these positions or motions. Moreover, since the signal strength of the plurality of detected signals is utilized and as the sensing signals are detected by the network devices arranged at different locations, more precise information on the environment of the network devices can be obtained as a plurality of different wireless transmission paths in the sensing area is present.

A position and/or a motion of at least one person in the lighting area can be detected based on the channel state information derived from the plurality of detected sensing signals and the predetermined generated wireless signal emitted by the transmitter. The channel state information can be indicative of the properties of the path that the wireless signal has taken from the wireless transmitter in the first network device to the wireless receiver in a second network device and thus describes how the wireless signal has propagated from the transmitter to the receiver. Accordingly, the channel state information can also be indicative of an interaction of the wireless signals with a person along the propagation path. Thus, the channel state information can provide very accurate information on the environment of the network with which the wireless signal is interacting. Since the predetermined generated wireless signal of the transmitter is known and due to the network characteristics of the network, the channel state information can be derived from the sensing signals.

The mobile electronic device can be implemented as a smartphone, a smartwatch, a tablet, a smart speaker, an augmented reality (AR) device, a virtual reality (VR) device, or any other wearable electronic devices. The mobile electronic device is associated to the person in the lighting area and it is assumed that the mobile electronic device is in the vicinity of the person. In other words, it is assumed that the person will take the electronic device with him, when he leaves the lighting area.

A motion detector can also be implemented as a radar sensor (a WiFi-based radar sensing, FMCW radar-based sensing, impulse UWB radar-based sensing or as a Time-of-Flight-based sensor).

If the lighting system does not comprise a main or central controller, a controller of one of the light unit can perform the prolonging of the holdtime for the light. The light unit can send a broadcast message to other lights in the lighting system to prolong the holdtime if a presence of a mobile device of a user is detected. Upon reception of such a broadcast message a light unit in the lighting system can prolong its holdtime.

In the presence scan mode the presence scanning can be performed continuously or at specific time intervals. Alternatively, the presence scanning can be activated before the end of the holdtime (e.g. x minutes before the end of the holdtime) or at any other time during the holdtime. The presence scanning can also be activated several times during the holdtime. This is advantageous as it will safe battery life as the scanning is only active when required.

The scanning in the presence scanning can be based on a Bluetooth protocol like Bluetooth Low Energy BLE. Hence, during the presence scanning both the mobile device as well as the light unit or the controller must have activated their Bluetooth transceivers. In particular, after a motion detection by motion detector (and possibly after a time period which is shorter than the holdtime) the mobile electronic device and the light or the controller must be activated. Preferably, the mobile electronic device, the controller or the controller of the light is activated during the holdtime to perform the presence detection. If the light unit or the controller communicate via other wireless protocol (e.g. ZigBee or WiFi) than this should also be activated.

The presence scanning can be performed based on RSSI or CSI measurements. The result of the RSSI or CSI measurements can be compared to a threshold. Only if the threshold is exceeded, a presence detection signal can be outputted.

The automated lighting system can also be able to handle multiple mobile electronic devices in the lighting area. Here, the mobile devices in the lighting area can be triggered by one of the controllers to transmit a RF signal. The controller can then start the presence scan. If one mobile electronic device (from one of the persons in the lighting area) is detected, then the holdtime is prolonged. Alternatively, the mobile electronic devices can perform the presence scanning. Once a presence of one mobile electronic device is detected optionally the holdtime of all lights in the lighting system is prolonged. Alternatively, only the holdtimes of some of the lights can be prolonged, in particular those lights in the vicinity of the detected mobile electronic device. This is advantageous for large lighting system where it is not necessary to activate all lights of the lighting system like in an open plan office.

In another aspect of the invention, a computer program product for performing a control of an automated lighting system is provided.

It shall be understood that the system, the method and the computer program product have similar and/or identical preferred examples or embodiments, in particular, as defined in the dependent claims.

It shall be understood that a preferred embodiment or example of the present invention can also be any combination of the dependent claims or above embodiments or examples with respective independent claims.

It shall be understood that the aspects described above and specifically the system of claim 1, the method of claim 8 and the computer program product according to claim 9 have similar and/or identical preferred embodiments, in particular as defined in the dependent claims.

These and other aspects of the invention will be apparent from and elucidated with reference to the embodiments described hereinafter.

### BRIEF DESCRIPTION OF THE DRAWINGS

In the following drawings:

FIGS. 1A and 1B each show a schematic block diagram of an automated lighting system,

FIGS. 2A and 2B each show a block diagram of an automated lighting system,

FIG. 3 shows flow chart of an operation of an automated lighting system, and

FIG. 4 shows a further flow chart of an operation of an automated lighting system.

### DETAILED DESCRIPTION OF EMBODIMENTS

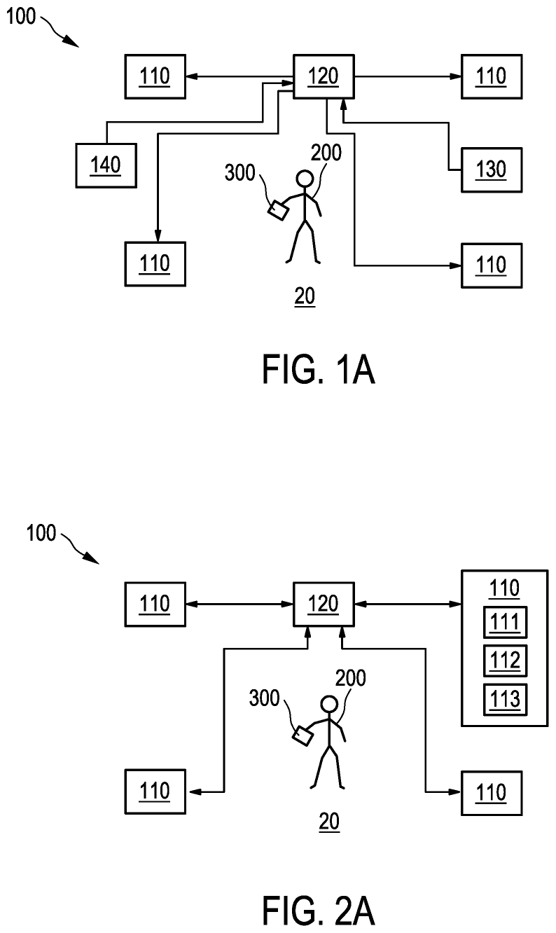

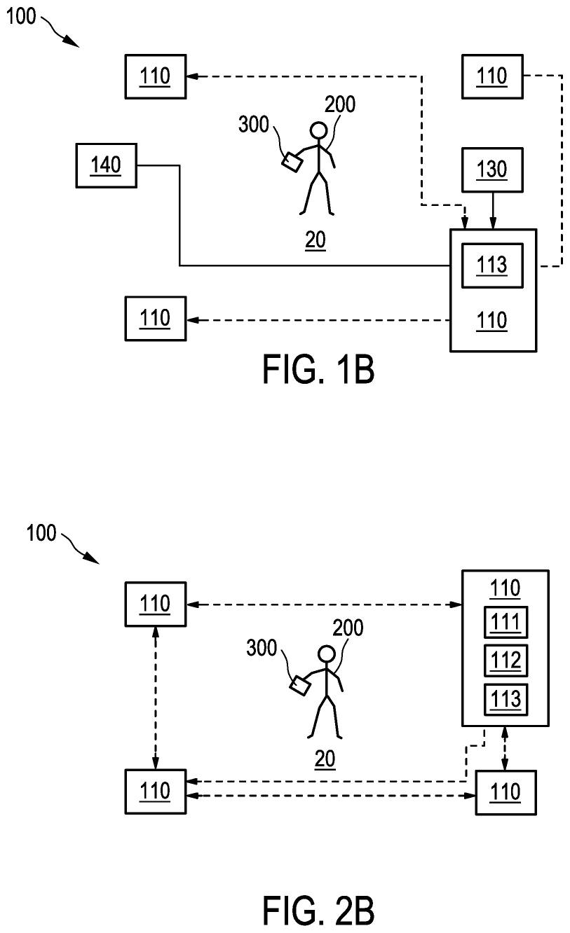

FIG. 1A shows a schematic block diagram of an automated lighting system. The automated lighting system 100 comprises at least one light unit 110, a main controller 120 and a motion detector 130. The main controller 120 can act as a central controller serves to control an operation of the lights 110, 120. The main controller 120 can activate a first operating mode, namely a normal operating mode, and a second operating mode, namely a presence scan mode. In the normal operating mode, the controller 120 receives a motion detection signal from the motion detector 130 and activates the lights 110. The controller 120 is also configured to provide a holdtime timer. During the holdtime of the holdtime timer, the respective lights 110 are switched on. After the holdtime timer has expired, and there was no motion during the holdtime, the main controller 120 in the first operating mode deactivates or switches off the lights.

The lights 100 comprise a light or luminaire 111, optionally a wireless transceiver 112 and optionally a controller 113. The wireless transceiver 112 can be capable of transmitting and/or receiving RF signals for communication with the main controller 120 and/or the other lights 110.

The motion detector 130 detects a motion of a user 200 in the lighting area 20. A mobile electronic device 300 can be associated to the user 200.

The motion detector 130 can be implemented as a PIR detector. Alternatively, the motion detector 130 can be implemented as a network of network devices including the light units 110.

The automated lighting system 100 can comprise a presence detector 140. The presence detector 140 can detect a presence of a mobile device 300 in the lighting area. This detection can be performed by scanning RF signals around the presence detector 140. If RF signals from the mobile device are detected, this will lead to the indication that the mobile device 300 together with the person 200 are still present in the lighting area 20, thus the lights should not be switched off. Accordingly, the controller in the presence scan mode can generate an interrupt signal based on the presence scan signals from the presence detector. The interrupt signal will result in the stopping of the holdtime timer or by resetting the holdtime timer.

The mobile electronic device 300 can optionally comprise a wireless transceiver 310 and a controller or an application 320 which can run on the mobile electronic device 300. The wireless transceiver 310 allows a communication based on RF signals.

FIG. 1B shows a schematic block diagram of an automated lighting system. The automated lighting system 100 comprises at least one light unit 110, and a motion detector 130. The light units 110 can comprise a controller 113. Hence, while in FIG. 1A a main controller is provided, here the controller is distributed and can be part of the light unit 110. One of the controller 113 serves to control an operation of the lights 110, 120. The controller 113 can activate a first operating mode, namely a normal operating mode, and a second operating mode, namely a presence scan mode. In the normal operating mode, the controller 113 receives a motion detection signal from the motion detector 130 and activates the lights 110. The controller 113 is also configured to provide a holdtime timer. During the holdtime of the holdtime timer, the respective lights 110 are switched on. After the holdtime timer has expired, and there was no motion during the holdtime, the controller 113 in the first operating mode deactivates or switches off the lights.

The lights 100 comprise a light or luminaire 111, optionally a wireless transceiver 112 and a controller 113. The wireless transceiver 112 can be capable of transmitting and/or receiving RF signals for communication with the main controller 120 and/or the other lights 110.

The motion detector 130 detects a motion of a user 200 in the lighting area 20. A mobile electronic device 300 can be associated to the user 200.

The motion detector 130 can be implemented as a PIR detector. Alternatively, the motion detector 130 can be implemented as a network of network devices including the light units 110.

The automated lighting system 100 can comprise a presence detector 140. The presence detector 140 can detect a presence of a mobile device 300 in the lighting area 20. This detection can be performed by scanning RF signals around the presence detector 140. If RF signals from the mobile device are detected, this will lead to the indication that the mobile device 300 together with the person 200 are still present in the lighting area 20, thus the lights should not be switched off. Accordingly, the controller in the presence scan mode can generate an interrupt signal based on the presence scan signals from the presence detector. The interrupt signal will result in the stopping of the holdtime timer or by resetting the holdtime timer.

The mobile electronic device 300 can optionally comprise a wireless transceiver 310 and a controller or an application 320 which can run on the mobile electronic device 300. The wireless transceiver 310 allows a communication based on RF signals.

FIG. 2A shows a block diagram of an automated lighting system. The automated lighting system 100 comprises several light units 110 and a main controller 120. In a lighting area 20, a user 200 with an associated mobile electronic device 300 is present. The light units 110 can act as network devices, thus a network of network devices is achieved. The light units can comprise a light 111, a wireless transceiver 112 and a light controller 113. The wireless transceiver is able to transmit and receive RF signals. Thus, one light unit can transmit an RF signal which interacts with the person 200 and can be received by a wireless transmitter 112 of another light unit. The interaction between the person and the RF signals can be used to detect a motion. Thus, the motion detector 130 can be integrated into the network of network devices. In other words, the network of network devices can perform a motion detection.

FIG. 2B shows a block diagram of an automated lighting system. The automated lighting system 100 comprises several light units 110. In a lighting area 20, a user 200 with an associated mobile electronic device 300 is present. The light units 110 can act as network devices, thus a network of network devices is achieved. The light units 110 can comprise a light 111, a wireless transceiver 112 and a controller 113. The wireless transceiver is able to transmit and receive RF signals. Thus, one light unit can transmit an RF signal which interacts with the person 200 and can be received by a wireless transmitter 112 of another light unit. The interaction between the person and the RF signals can be used to detect a motion. Thus, the motion detector 130 can be integrated into the network of network devices. In other words, the network of network devices can perform a motion detection.

While in FIG. 2A the control is performed in the main controller according to FIG. 2B the control is performed in the controller 113 of the light unit, i.e. a distributed control can be performed.

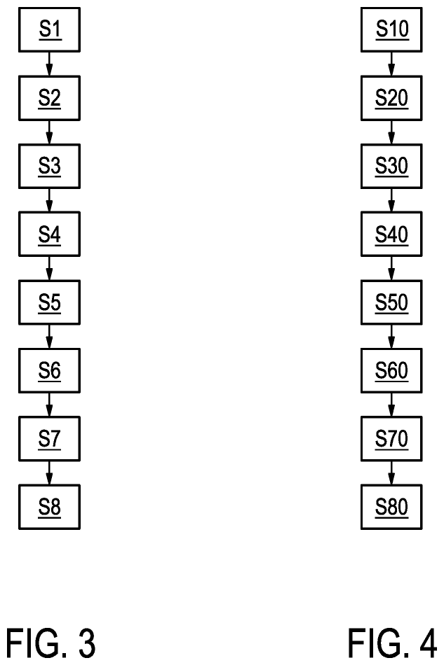

FIG. 3 shows flow chart of an operation of an automated lighting system. The automated lighting system 100 comprises at least one light unit 110, a main controller 120 and a motion detector 130. The main controller 120 serves to control an operation of the lights 110, 120. The main controller 120 can activate a first operating mode, namely a normal operating mode, and a second operating mode, namely a presence scan mode. In the normal operating mode, the controller 120 receives a motion detection signal from the motion detector 130 and activates the lights 110. The controller 120 is also configured to provide a holdtime timer. During the holdtime of the holdtime timer, the respective lights 110 are switched on. After the holdtime timer has expired, the main controller 120 in the first operating mode deactivates or switches off the lights.

The motion detector 130 detects a motion of a user 200 in the lighting area 20 and forwards a motion detection signal. A mobile electronic device 300 can be associated to the user 200.

In step S1 the main controller 120 is operated in a normal operating mode and receives the motion detection signal and determines whether a motion is detected in the lighting area 20. If a motion is detected the flow continues to step S2. In step S2 the main controller 120 activates at least one of the lights. In step S3 a hold timer for a holdtime is started. During the holdtime the lights remain switched on. In step S4 the main controller 120 activates a presence detection mode and sends a message to the electronic device or triggers an event in the mobile electronic device. In step S5 the mobile device receives the message or triggers an event in the mobile device. Thus, the mobile device activates a transceiver or a receiver and scan for RF signals from the lights 110 or the main controller 120. In step S6, the mobile device informs the main controller when it has detected a RF signal from one of the lights. In step S7, the main controller generates an interrupt signal to interrupt the hold timer or to reset the hold timer. In any case the light will not be switched of but remain switched on. In step S8 the main controller will switch off the lights 110 when no mobile electronic device is detected.

The detection of the mobile electronic device by one of the lights or the main controller is used an indication that the person 200 with which the mobile electronic device is associated to is still in the lighting area 20 and therefore the lights should remain switched on.

FIG. 4 shows flow chart of an operation of an automated lighting system. The automated lighting system 100 comprises at least one light unit 110, a main controller 120 and a motion detector 130. The main controller 120 serves to control an operation of the lights 110, 120. The main controller 120 can activate a first operating mode, namely a normal operating mode, and a second operating mode, namely a presence scan mode. In the normal operating mode, the controller 120 receives a motion detection signal from the motion detector 130 and activates the lights 110. The controller 120 is also configured to provide a holdtime timer. During the holdtime of the holdtime timer, the respective lights 110 are switched on. After the holdtime timer has expired, the main controller 120 in the first operating mode deactivates or switches off the lights.

The motion detector 130 detects a motion of a user 200 in the lighting area 20 and forwards a motion detection signal. A mobile electronic device 300 can be associated to the user 200.

In step S10 the main controller 120 is operated in a normal operating mode and receives the motion detection signal and determines whether a motion is detected in the lighting area 20. If a motion is detected the flow continues to step S20. In step S20 the main controller 120 activates at least one of the lights. In step S30 a hold timer for a holdtime is started. During the holdtime the lights remain switched on. In step S40 the main controller 120 activates a presence detection mode and activates a presence scan by sending a message to the electronic device or triggers an event in the mobile electronic device 300. In step S50 the mobile device 300 receives the message or triggers an event in the mobile electronic device. Thus, the mobile device 300 activates a transmitter and send RF signals. In step S60 the lights and/or the main controller 120 scan for RF signals from the mobile electronic device 300. In step S70, the main controller 120 generates an interrupt signal to interrupt the hold timer or to reset the hold timer if the main controller 120 and/or the lights 110 have detected RF signals from the mobile electronic device 300. In any case the light will not be switched of but remain switched on. In step S90 the main controller will switch off the lights 110 when no mobile electronic device 300 is detected.

According to an example, the lights can—in contrast to their normal operating mode—start to send RF signals, or start to scan for messages (e.g. based on the Bluetooth Low Energy BLE protocol) for example when a motion is detected in the lighting area. The lights can be able to initiate a BLE connection. However, typically the Bluetooth connection is turned off as soon as the lights have been connected to a controller or bridge or are using WIFI for communication. This procedure can be performed because off security reasons. In this example however, a Bluetooth connection can be activated to scan for mobile electronic devices. There is no need to initiate a connection to the mobile electronic device. For the presence detection it is sufficient detect that the mobile electronic device is in the lighting area. After the holdtime has expired, the Bluetooth can be deactivated again. The lights can be embodied as Zigbee light with BLE capabilities, and/or as Wifi lamps with BLE capabilities.

According to an example, the motion detector can be implemented as a network of network devices. Such network devices can be regarded as any device adapted to form a network with other network devices. In particular, a network device comprises a network device communicator that is adapted to receive and transmit wired or wireless signals, for instance, radiofrequency signals, infrared signals, transmit and receive audio signals for audio sensing purposes, electrical signals, etc.

The network between the network devices can then be formed through a communication between the network devices following a known network communication protocol like WiFi, ZigBee, Thread, Bluetooth, etc. Preferably, the network devices refer to smart devices, i.e. devices comprising a communication unit for receiving and transmitting network communication signals but which otherwise fulfil the function of a corresponding conventional device. In particular, such a smart device can be a smart home or office device, in which case the corresponding conventional function would be that of a conventional home or office device. Preferably, the conventional function refers to a lighting function and the network devices refer to network lighting devices that are further adapted to comprise a wireless transmitter and/or a wireless receiver. Optionally the network devices can also comprise a sound generator and/or a sound detector for audio sensing. However, the network devices can also refer, for instance, to smart plugs, smart switches, etc.

The system can be part of the network, for instance, can be part of one or more of the network devices. In particular, the system can be provided as hard-and/or software as part of one of the network devices or distributed over a plurality of the network devices that are in communication with each other to form the system. However, the system can also be provided as a standalone system, for instance, in a device that is not part of the network of network devices but is directly or indirectly in communication with at least one of the network devices, for instance, to control the network devices. For instance, the system can be provided as part of a handheld computational device like a smartphone, a tablet computer, a laptop etc. However, the system can also be located in a cloud formed by one or more servers, wherein in this case the system might communicate with the network, in particular, the network devices, via one or more devices that are connected to the cloud like a router.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

1. An automated lighting system, comprising
at least one light configured to illuminate at least part of a lighting area,
at least one motion detector configured to detect a motion of at least one person in a lighting area and to output a motion detection signal,
a controller being configured to control an operation of the at least one light in a normal operating mode based on the motion detection signal and in a presence scan mode, wherein the presence scan mode is activated by the controller after activation of the at least one light,
wherein the controller is configured to activate the at least one light dependent on a motion detection signal in a normal operating mode, and to deactivate the light after a holdtime,
wherein in the presence scan mode a presence of at least one mobile electronic device associated to at least one person in the lighting area is detected and a presence detection signal is outputted.
wherein the controller is configured to interrupt the deactivation of the light before the hold time expires based on the presence detection signal, further comprising
a presence detector configured to detect a presence of a mobile electronic device associated to a person in the lighting area and to output the presence detection signal, and
wherein
in the presence scan mode the controller is configured to forward a notification or message to the mobile electronic device to start scanning for RF signals from the lights and/or the controller;
wherein the mobile electronic device is configured to transmit a presence scanning notification or message to the controller, if it has detected RF signals from the lights and/or a controller,
wherein the controller is configured to interrupt the deactivation of the light before the hold time expires based on the presence detection notification from the mobile electronic device.

2. Automated lighting system according to claim 1, wherein
in the present scan mode, one of the lights and/or the controller can initiate an RF signal scanning,
wherein if the RF signal scanning detects the mobile electronic device, then a presence detection signal is forwarded to the controller.

3. Automated lighting system according to claim 2, wherein
in the present scan mode the controller is configured to forward a notification or message to the mobile electronic device to start transmitting RF signal, which can be detected by the lights and/or the controller,
wherein the lights and/or the controller generate the presence detection signal.

4. Automated lighting system according to claim 2, wherein
the motion detector comprises a passive infrared sensor for motion detection.

5. Automated lighting system according to claim 2, wherein
the motion detector is implemented as a network of network devices,
wherein the lights serve as network devices, and which is configured to perform an RF-based motion sensing.

6. Method of controlling an automated lighting system, which comprises at least one light configured to illuminate at least part of a lighting area, comprising the steps of:
detecting a motion of a person in a lighting area by at least one motion detector and outputting a motion detection signal,
controlling an operation of the at least one light in a normal operating mode based on the motion detection signal and in a presence scan mode by a controller, wherein the presence scan mode is activated by the controller after activation of the at least one light,
activate the at least one light based on a motion detection signal in a normal operating mode, and deactivating the light after a holdtime,
in the presence scan mode a presence of a mobile electronic device associated to the person in the lighting area is detected and a presence detection signal is outputted, and
interrupting the deactivation of the light before the holdtime expires based on the presence detection signal,
wherein the method further comprises:
detecting, by a presence detector, a presence of a mobile electronic device associated to a person in the lighting area and to output the presence detection signal, and
in the presence scan mode forwarding, by the controller, a notification or message to the mobile electronic device to start scanning for RF signals from the lights and/or the controller;
transmitting, by the mobile electronic device, a presence scanning notification or message to the controller, if it has detected RF signals from the lights and/or a controller,
interrupting, by the controller, the deactivation of the light before the hold time expires based on the presence detection notification from the mobile electronic device.

7. A computer program product for controlling an automated lighting system, wherein the computer program product comprises program code means for controlling an automated lighting system of claim 1 to execute the method according to claim 6.
